(19) United States
(12) Patent Application Publication
(10) Pub. No.: US 2009/0291258 A1
(43) Pub. Date: Nov. 26, 2009

(54) BASE TREATMENT METHOD OF A POLYESTER FILM AND POLYESTER FILM ARTICLE PRODUCED BY THEREOF

(75) Inventor: Souichiro Higashi, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/295,178

(22) PCT Filed: Mar. 29, 2007
(86) PCT No.: PCT/JP2007/057621

§ 371 Date: Sep. 29, 2008

(30) Foreign Application Priority Data
Mar. 31, 2006 (JP) 2006-100295

(51) Int. Cl. B32B 3/30; B05D 3/04

(52) U.S. Cl. 428/141; 427/536

(57) ABSTRACT

To provide a base treatment method of a polyester film which can attain high adhesion with a coated layer even without roughening the surface of the polyester film, and a polyester film article produced using such method. The present invention subjects a surface of a polyester film having a surface roughness Ra of no less than 0.5 nm and no more than 1.0 nm to a remote plasma treatment, to introduce a functional group thereon. For O₂ or CO₂, the functional group is set in a range which satisfies 0.45<O/C<0.55, and for an N₂ or NH₃ plasma, the functional group is set in a range which satisfies 0.05<N/C<0.3.

### TECHNICAL FIELD

The present invention relates to a base treatment method of a polyester film, and a polyester film article produced using such method. The present invention especially relates to a base treatment method for coating a primer layer on the support of a polyester film with a silver halide photosensitive material to be used for medical diagnostics, industrial photography, printing or COM, and a polyester film article produced using such method.

### BACKGROUND ART

Silver halide photosensitive materials are used as a primer layer which is coated in between a polyester film (support) and a hydrophilic colloid photosensitive layer to adhere these materials together (refer to Japanese Patent Application Laid-Open No. 6-27589). To improve the adhesion between the polyester film and the primer layer, the surface of the polyester film is normally roughened during the coating of the primer layer. For example, the surface of the polyester film is roughened by subjecting the polyester film to a corona discharge treatment, and then the primer layer is coated onto the surface (e.g. refer to Japanese Patent Application Laid-Open No. 2000-80183).

However, recently polyester films having low surface roughness are being demanded. Especially when coating a thin primer layer or a thin photosensitive layer, the surface roughness of the polyester film has to be decreased.

### DISCLOSURE OF THE INVENTION

However, if the surface roughness of the polyester film decreases, the adhesion between the polyester film and the primer layer also decreases, whereby the primer layer may peel away from the polyester film.

The present invention was created in view of such problems. It is thus an object of the present invention to provide a base treatment method of a polyester Elm which can attain high adhesion with a coated layer (e.g. a primer layer) even without roughening the surface of the polyester film, and a polyester film article produced using such method.

To achieve the above-described object, a first aspect of the present invention provides a base treatment method of a polyester film characterized by subjecting the surface of a polyester film having a surface roughness Ra of no less than 0.5 nm and no more than 1.0 nm to a remote plasma treatment, to introduce a functional group thereon.

The inventor of the present invention made the discovery that if the surface of a polyester film is modified by subjecting the surface to a remote plasma treatment, adhesion with a coated layer can be improved even without roughening the surface of the polyester film.

The present invention was created based on this discovery, which enables adhesion with a coated layer having a very low surface roughness Ra to be improved as a result of subjecting the surface of a polyester film having a surface roughness Ra of no less than 0.5 nm and no more than 1.0 nm to a remote plasma treatment to introduce a functional group thereon.

A second aspect of the present invention is characterized in that, in the first aspect, the polyester film is a polyethylene terephthalate film. The present invention is especially suitable for base treatment of a polyethylene terephthalate film.

A third aspect of the present invention is characterized in that, in the first or second aspect, the remote plasma treatment is carried out with an O₂ or CO₂ plasma, and the functional group is set in a range which satisfies 0.45<O/C<0.55.

A fourth aspect of the present invention is characterized in that, in the first or second aspect, the remote plasma treatment is carried out with an N₂ or NH₃ plasma, and the functional group is set in a range which satisfies 0.05<N/C<0.3.

The inventor of the present invention discovered that even if a remote plasma treatment is carried out, depending on the treatment conditions fine grains consisting of the film material that have ruptured during treatment can adhere to the surface of the film causing a weak bound layer (hereinafter “WBL”) to form, whereby adhesion with the coated layer does not improve much. Therefore, if the treatment conditions are set so that a WBL does not form, adhesion with the coated layer will improve as a result of the anchor effect. According to the third or fourth aspect of the present invention, the remote plasma treatment conditions are set as described above, which enables adhesion between the film surface and the coated layer to improve.

A fifth aspect of the present invention is characterized in that, in the any of the first to fourth aspects, a water-based base primer layer is coated onto a surface of the polyester film which has been subjected to remote plasma. According to the fifth aspect, a water-based primer layer and a polyester film can be adhered with a high degree of adhesion.

A sixth aspect of the present invention is a polyester film article characterized by being produced by subjecting a surface of a polyester film having a surface roughness Ra of no less than 0.5 nm and no more than 1.0 nm to a remote plasma treatment, to introduce a functional group thereon.

According to the present invention, because a functional group is introduced by subjecting the surface of a polyester film to a remote plasma treatment, adhesion with a coated layer can be improved even without roughening the surface of the polyester film.

### BRIEF DESCRIPTION OF THE DRAWINGS

FIG. 1 is a block diagram illustrating a production process of the silver halide photosensitive material used in the present invention;

FIG. 2 is a cross-sectional view of the polyester film article produced using the production process of FIG. 1;

FIG. 3 is a structural diagram illustrating the primer layer coating apparatus used in the present invention;

FIG. 4 is a structural diagram of a remote plasma treatment apparatus;

FIG. 5 is a table showing the results of an experiment carried out to determine the effects of remote plasma treatment;

FIG. 6 is a graph illustrating the relationship between surface roughness and functional group content based on FIG. 5;

FIG. 7 is a table showing the results of an experiment carried out to determine suitable treatment conditions for O/C;

FIG. 8 is a graph illustrating the relationship between functional group content and adhesive strength based on FIG. 7;

FIG. 9 is a table showing the results of an experiment carried out to determine suitable treatment conditions for N/C;

FIG. 10 is a graph illustrating the relationship between functional group content and adhesive strength based on FIG. 9; and

FIG. 11 is a graph illustrating the relationship between surface tension and adhesive strength.

### DESCRIPTION OF SYMBOLS

10 Base treatment apparatus
12 Polyester film
16 Plasma generator
22 Electrode
24 Primer layer coating apparatus
26 Drying apparatus

### BEST MODE FOR CARRYING OUT THE INVENTION

A preferable embodiment of the base treatment method of a polyester film according to the present invention, and polyester film article produced using such method, will now be explained with reference to the attached drawings and by using an example wherein a silver halide photosensitive material was used as one example.

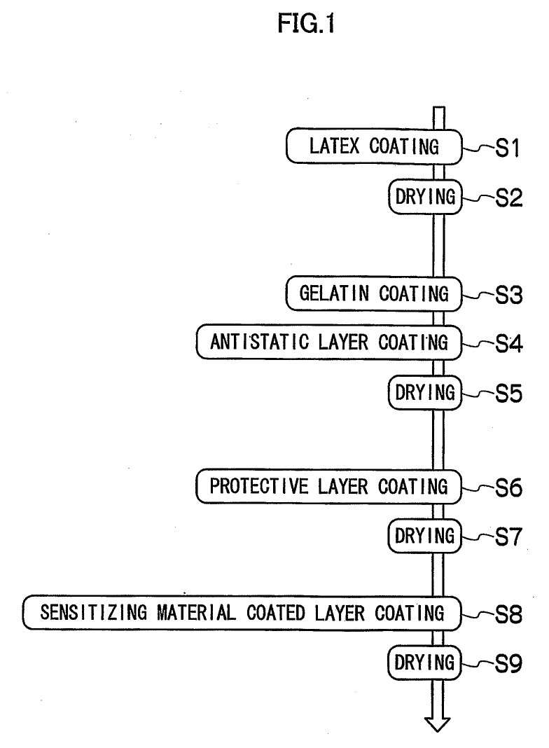

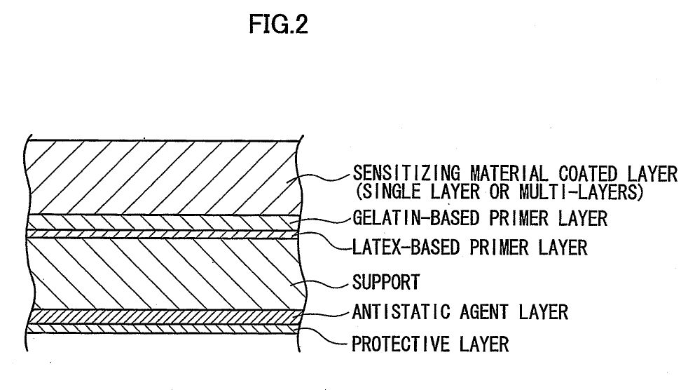

First, the production process of the silver halide photosensitive material used in the present invention will be explained. FIG. 1 is a block diagram schematically illustrating one example of a production process of a silver halide photosensitive material. FIG. 2 is a cross-sectional view illustrating a polyester film article produced using this production process.

As illustrated in FIG. 1, in a production process of a silver halide photosensitive material, first, a latex-based primer solution is coated onto the surface side of a support (polyester film) (step S1), and this is dried (step S2) to form a latex-based primer layer. Next, a gelatin-based primer solution is coated onto the surface of the latex-based coated layer (step S3). An antistatic agent layer coating solution is then coated onto the underside of the support (step S4), and this is dried (step S5) to form a gelatin-based primer layer and an antistatic agent layer. Next, a protective layer coating solution is coated onto the underside of the gelatin-based primer layer (step S6), and this is dried (step S7) to form a protective layer. A sensitizing coating solution is coated onto the surface side of the gelatin-based primer layer (step S8), and this is dried (step S9) to form a monolayer or multilayer sensitized coated layer. The photosensitive material of FIG. 2 is formed in this manner.

The base treatment method according to the present invention can be, for example, applied when forming the primer layer in steps S1, S2. By applying the present invention, the adhesion between the latex-based primer layer and the support can be improved without increasing the surface roughness Ra of the support.

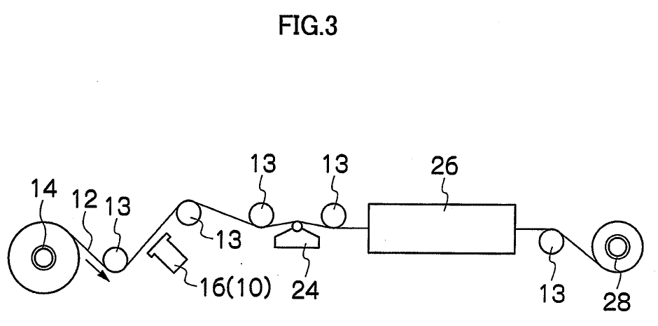

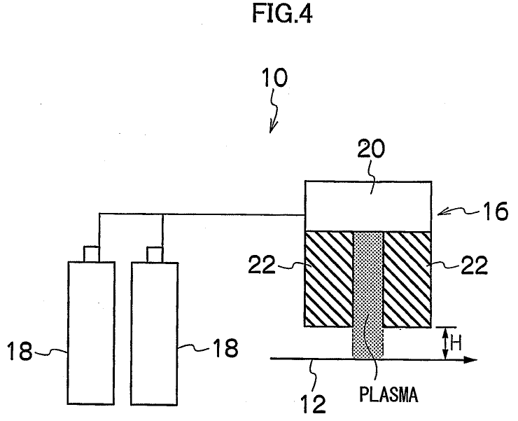

A primer layer coating apparatus embodiment will now be explained based on FIGS. 3 and 4. FIG. 3 illustrates the primer layer coating apparatus which is used in the present invention. FIG. 4 is a structural diagram of a remote plasma treatment apparatus.

As illustrated in FIG. 3, a polyester film 12 is wound in a roll shape onto a feed roller 14, and the polyester film 12 is fed from this feed roller 14. The fed polyester film 12 travels while being guided by guide rollers 13, 13, and undergoes remote plasma treatment by a plasma generator 16 of a remote plasma treatment apparatus 10.

As illustrated in FIG. 4, the remote plasma treatment apparatus 10 comprises a plasma generator 16 which generates plasma, and tanks 18, 18 which store two kinds of compressed gas. The tanks 18, 18 are connected to a mixing section 20 of the plasma generator 16. The two kinds of gas are supplied to the mixing section 20 and mixed therein. Examples of gases which may be used include O₂, CO₂, N₂, NH₃ and the Hike. The functional group content is set depending on the kind of gas. For example, for O₂ or CO₂, the content is set in a range which satisfies 0.45<O/C<0.55, and for an N₂ or NH₃ plasma, the content is set in a range which satisfies 0.05<N/C<0.3.

The gases mixed at the mixing section 20 of the plasma generator 16 are blown downwards between electrodes 22, 22. Therefore, by applying a voltage to the electrodes 22, 22, plasma can be generated.

The plasma generator 16 is provided at a position away from the polyester film 12. The distance H of the plasma generator 16 from the polyester film 12 is, for example, 60 to 100 cm, and about 80 cm is especially preferable. By performing the plasma treatment in this manner at a position away from the polyester film 12, adhesive strength with the below-described primer layer can be improved without roughening the surface of the polyester film 12.

The plasma generating device in the plasma generator 16 is not especially limited. Examples which can be used include a high-frequency excitation system, discharge plasma generating device using direct current, a vacuum/low pressure system plasma generating device and an atmospheric plasma generating device.

The remote plasma treated polyester film 12 is coated with a primer solution using the primer solution coating apparatus 24 of FIG. 3. The primer solution is then dried using a drying apparatus 26 to form a primer layer. Since the surface of the polyester film 12 is subjected to remote plasma treatment during this step, adhesion can be improved between the primer layer and the polyester film 12. Subsequently, the polyester film 12 formed with the primer layer is taken up by a take-up roller 28.

Next, the results of an experiment which forms the basis of the present invention will be explained.

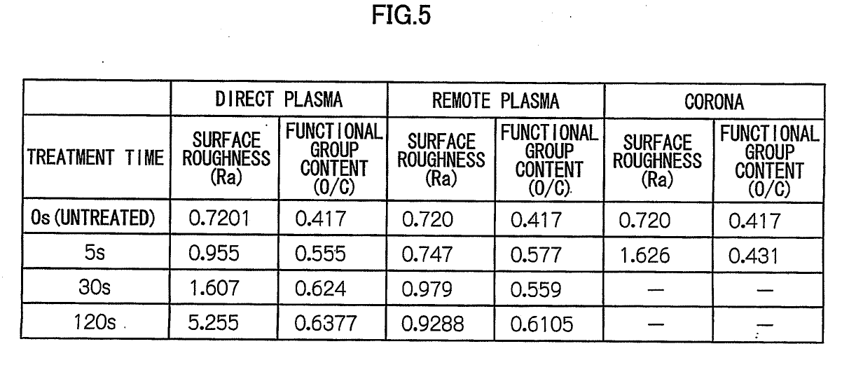

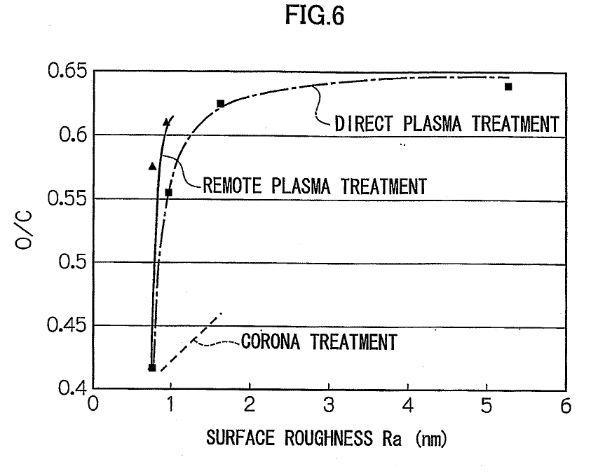

First, the results of an experiment carried out to investigate the effects of surface modification from remote plasma treatment will be explained. In this experiment, a polyester film (e.g. a polyethylene terephthalate film; hereinafter simply referred to as “film”) was subjected to a corona treatment, direct plasma treatment and remote plasma treatment, and the surface roughness Ra when the coating solution was coated and the functional group content O/C were examined. The film that was used had a thickness of 175 μm and a surface roughness Ra of 0.72. The remote plasma treatment conditions were: a plasma treatment apparatus from the Inagaki Laboratory, Faculty of Engineering, Shizuoka University, power output of 100 W at 13.56 MW, ambient gas (O₂, CO₂, N₂ and NH₃) at 10 cc/min, treatment time of 5, 30 and 120 sec, and an internal pressure of 0.1 Torr. Used as the coating solution were a PVA-based simuilation solution (a water-based solution having a 5% concentration of each of PVA and a surfactant) and a gelatin-based simulation solution (a water-based solution having a 2% solid content including gelatin). The results from this experiment are illustrated in FIG. 5 as a table. FIG. 6 illustrates the relationship between surface roughness and functional group content.

As can be understood from these Figures, surface roughness Ra of the film does not fall below 1 nm for a corona treatment. This is because with a corona treatment the surface is easily etched even at low power. Also, for corona treatment, the functional group content doped on the surface is small. Thus, corona treatment has the problems of being unable to decrease surface roughness of the film, and improve the adhesion with the coated layer.

Direct plasma treatment performs film surface treatment in the plasma region. As can be understood from FIGS. 5 and 6, surface roughness Ra increases in conjunction with an increase in functional group content, so that when surface roughness Ra is 1 nm or less it is difficult to improve the adhesion with the coated layer by increasing the functional group content. In addition, in direct plasma treatment side reactions occur due to the collision or action of charged species, giving rise to the problem that surface treatment is easily inhibited.

In contrast, as illustrated in FIGS. 5 and 6, remote plasma treatment can increase functional group content while suppressing surface roughness Ra to no more than 1 nm. This is due to the fact that in remote plasma treatment the treatment is performed with the film positioned away from the plasma region, so that the film is not directly exposed to the plasma, and thus the film is not affected by the plasma region, or more specifically, the film is not directly affected by charged species such as ions or electrons in the plasma region. Therefore, remote plasma treatment enables proactive or selective action of the radical species generated in the plasma region, whereby functional group content can be increased by giving priority to a desired reaction while suppressing side reactions as much as possible.

Thus, unlike corona treatment or direct plasma treatment, remote plasma treatment can increase functional group content while suppressing surface roughness Ra to no more than 1 nm. The present invention utilizes such remote plasma treatment, wherein the surface of a PET film not yet coated with a primer layer is subjected to remote plasma treatment, thereby allowing adhesion with the primer layer to be improved while suppressing surface roughness Ra of the film to no more than 1 nm.

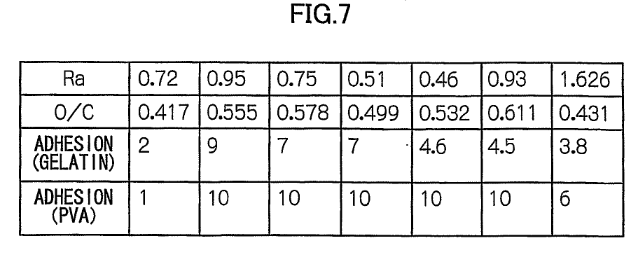

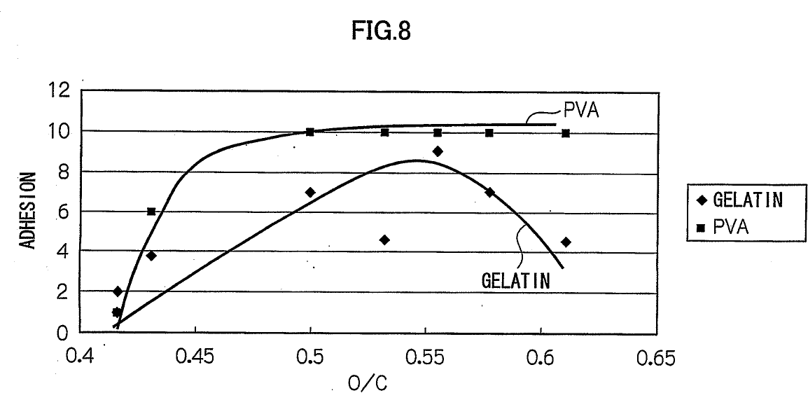

Next, the results of an experiment carried out to determine preferable treatment conditions for remote plasma treatment will be explained. This experiment was carried out to determine the relationship between the treatment conditions of remote plasma treatment and adhesion with respect to the primer layer. A polyester film was subjected to O₂ or CO₂ remote plasma treatment, and then coated with two kinds of coating solution. The functional group content O/C and adhesion of the primer layer were measured. The polyester film, remote plasma treatment and coating solution conditions were all the same as in the above-described experiment. The method for evaluating adhesion with respect to the coated layer will be described later. To remove the effects of surface roughness, the conditions (treatment time, distance) were adjusted so that Ra was less than 1. The results of the experiment are shown in FIG. 7 as a table. FIG. 8 illustrates the relationship between functional group content and adhesive strength.

As illustrated in these Figures, when the primer layer was PVA, adhesion with the primer layer improved for O/C>0.45. When the primer layer was gelatin, adhesion increased in conjunction with an increase in O/C when O/C was less than 0.55, but decreased when O/C was 0.55 or more. Therefore, the results showed that adhesion with the primer layer surely improves in the range of 0.45<O/C<0.55 regardless of the kind of primer layer.

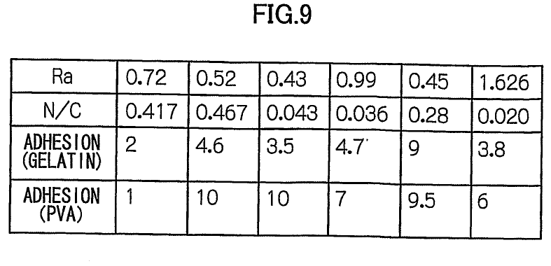

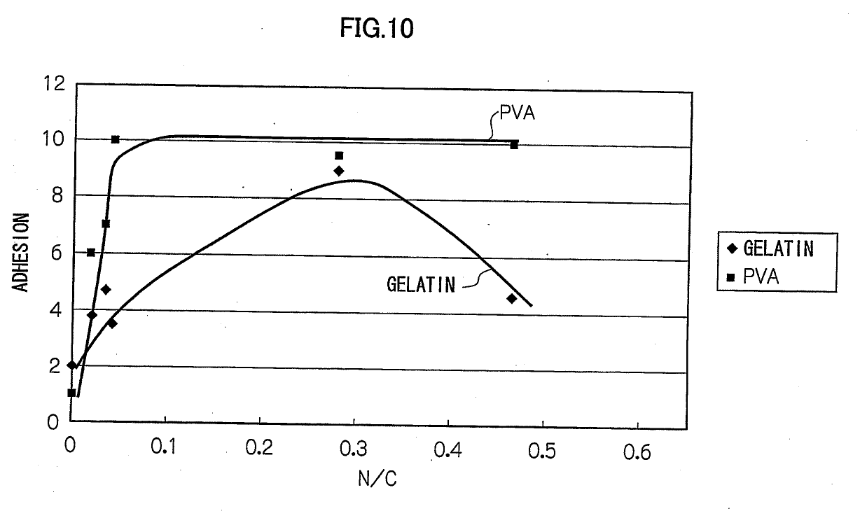

Subsequently, a polyester film was subjected to N₂ or NH₃ remote plasma treatment, and then coated with two kinds of coating solution. The functional group content N/C and adhesion of the primer layer were measured. The polyester film, remote plasma treatment and coating solution conditions were all the same as in the above-described experiment. To remove the effects of surface roughness, the conditions (treatment time, distance) were adjusted so that Ra was less than 1. The results of the experiment are shown in FIG. 9 as a table. FIG. 10 illustrates the relationship between functional group content and adhesive strength.

As illustrated in these Figures, when the primer layer was PVA, adhesion with the primer layer improved for N/C>0.05. When the primer layer was gelatin, adhesion increased in conjunction with an increase in N/C when N/C was less than 0.3, but decreased when N/C was 0.3 or more. Therefore, the results showed that adhesion with the primer layer surely improves in the range of 0.05<O/C<0.3 regardless of the kind of primer layer.

Based on the above experiment results, when subjecting the surface of a film to remote plasma treatment, in the case of O₂ or CO₂ it is preferable to set the content in the range of 0.45<O/C<0.55, while in the case of N₂ or NH₃ it is preferable to set the content in the range of 0.05<N/C<0.3.

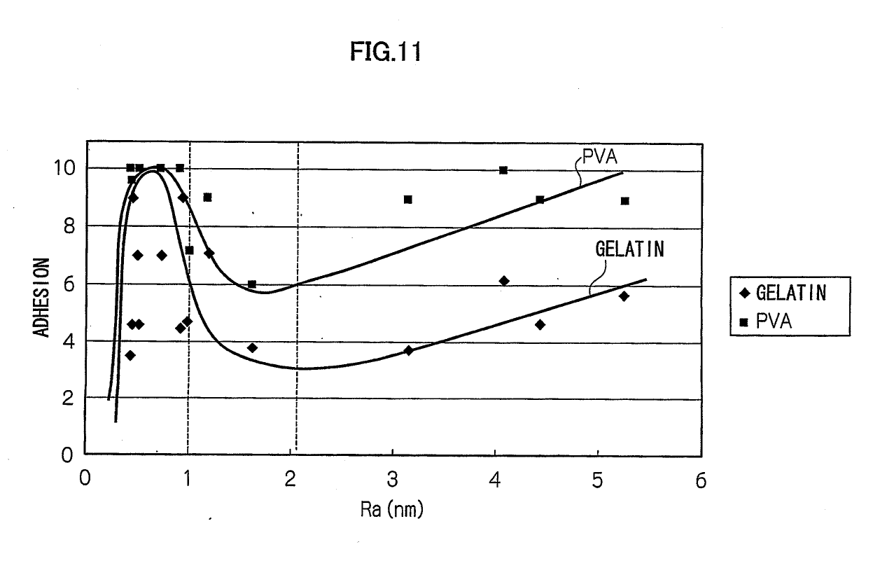

Next, the results of an experiment carried out to determine the relationship between surface roughness Ra during remote plasma treatment and adhesion will be explained. In this experiment, polyester films having different surface roughnesses were subjected to remote plasma treatment under varying treatment conditions, coated with two kinds of primer solution, a gelatin-based and a PVA-based, and adhesion was measured. The results are shown in FIG. 11.

As can be seen from FIG. 11, when the surface roughness Ra of a film is 1.0 nm or more, adhesive strength tends to decrease as the surface roughness Ra increases. This is because adhesive strength arises from the anchor effect resulting from surface being roughened. Therefore, while adhesive strength decreases as surface roughness Ra decreases, adhesive strength dramatically improves if surface roughness Ra is 0.5 to 1.0 nm. This illustrates the point that for a surface which has been subjected to remote plasma treatment so that its reflective sheet is from 0.5 to 1.0 nm, the improvement in adhesion as a result of introducing a functional group is notably expressed. Thus, in the present invention it is preferable to perform a base treatment on a polyester film having a surface roughness Ra of 0.5 to 1.0 nm.

The method for evaluating adhesion in the above-described experiments will now be described.

### (1) Experiment for Evaluating Dry Adhesion of PVA

A PVA primer layer was formed with a hand-coating cloth (bar coater) onto the surface of a PET film which had been subjected to remote plasma treatment. The resultant object was dried in a thermostat bath, and then the following dry adhesion evaluation was carried out.

The coating of the primer layer was carried out using an approximately 1.5% solution of PVA, with a wet coating amount of 7.1 cc/m², a wet film thickness of 7.1 μm and a dry film of 0.01 μm.

In the dry adhesion evaluation, lattice-like slits were cut into the coated surface with a cutter, and tape was stuck thereover. The surface area of the peeled sections of the coated film when peeled away was cursorily confirmed by eye and evaluated over 10 stages. In the adhesion evaluation, the higher the number, the larger is the adhesion with the primer layer, so that “0” represents complete peeling and “10” represent no peeling.

### (2) Experiment for Evaluating Gelatin Wet Adhesion

A gelatin primer layer was formed with a hand-coating cloth (bar coater) onto the surface of a PET film which had been subjected to remote plasma treatment. The resultant object was dried in a thermostat bath, and then the following wet adhesion evaluation was carried out.

The coating of the primer layer was carried out using a gelatin-based solution having a solid content concentration of approximately 1.6%, with a wet coating amount of 9.8 cc/m₂, a wet film thickness of 9.8 μm and a dry film of 0.16 μm.

In wet adhesion evaluation, the sample was dipped in water, rubbed using an adhesion testing machine, dried and then evaluated over 10 stages. In the adhesion evaluation, the higher the number, the larger is the adhesion with the primer layer, so that “0” represents complete peeling and “10” represent no peeling.

In the above-described experiments, surface roughness was measured using a “SPA400” manufactured by Shimadzu Corporation. Surface element analysis and functional group analysis were carried out using an “Axis-His” manufactured by ESCA Shimadzu Corporation.

Specific examples of the silver halide photosensitive material according to the present invention will now be explained.

First, the primer layer will be explained. The coating solution for the primer layer contains a hydrophilic colloid. Examples of the hydrophilic colloid include gelatin; acylated gelatins such as phthalized gelatin, maleated gelatin and the like; cellulose derivatives such as carboxymethyl cellulose, hydroxyethyl cellulose and the like; graft gelatin such as gelatin grafted with acrylic acid, methacrylic acid, an amide (acrylamide etc.); polyvinyl alcohol; polyhydroxyalkyl acrylate; polyvinylpyrrolidone; copolyvinylpyrrolidone-vinyl acetate; casein; agarose; albumin; sodium alginate; polysaccharide; agar; starch; grafted starch; polyacrylamide; polyethyleneimine-acylate; and the synthetic or natural hydrophilic polymer compounds thereof such as partially hydrolyzed products or the like. These materials can be used solely or as a mixture thereof. Among the examples, gelatin is preferred. In addition to the hydrophilic colloids, acrylic resin, polyester resin, polyurethane resin, polystyrene resin, SBR, PVDC or the like can also be used therewith as a binder.

The coating solution for the primer layer is preferably held at a temperature of 50 to 80° C. for 10 minutes to 5 hours prior to forming the primer layer. More preferable is at a temperature of 60 to 70° C. for 30 minutes to 3 hours, and still more preferable is at a temperature of 60 to 70° C. for 1 to 2 hours.

From the perspective of stability of the coating solution, the coating solution for the primer layer preferably has a pH of 4 to 8. More preferable is 5 to 8, and still more preferable is 6 to 7.

Form the perspective of suppressing cissing during coating, the coating solution for the primer layer preferably contains a monovalent saturated alcohol having 3 or less carbon atoms. Preferable examples of such a monovalent saturated alcohol include methanol, ethanol, propanol, isobutanol and the like. These monovalent saturated alcohols may be used alone, or in combination of two or more thereof. Further, while these monovalent saturated alcohols are intentionally added to achieve the above-described object of the invention, they may be added together with a below-described solvent, or may be mixed in the coating solution as a solvent of the material contained in the coating solution, or as a solvent to be used in the synthesis or purification of the material, or as a washing solvent of the chemical storage tanks, pipes or the like. However, the alcohol content in the coating solution is preferably no more than 20% by weight, and is more preferably 1 to 10% by weight.

The coating solution for the primer layer may contain a crosslinking agent, matting agent, dye, filler, surfactant and the like. Examples of crosslinking agents which can be used include well-known compounds such as epoxies, isocyanates and melamines. Further, the active halogen crosslinking agents disclosed in Japanese Patent Application Laid-Open No. 51-114120 are also preferable. The matting agent is preferably used to improve a rapid conveyance property during production. As the matting agent, fine grains of styrene, polymethylmethacrylate, silica and the like may be used which have an average grain size of about 0.1 to 8 μm, and more preferably about 0.2 to 5 μm. The used amount of matting agent is preferably, per 1 m² of heat-developable photosensitive material, 1 to 200 mg and more preferably 2 to 100 mg. As the filler, colloidal silica or the like may be used. As the surfactant, anionic, nonionic or cationic surfactants may be used. As the dye, antihalation or dyes for color tone regulation may be used.

The primer layer coating solution may be either water-based or organic solvent-based, although in terms of cost and the environment, a water-based coating solution is preferable. Here, “water-based coating solution” refers to a coating solution having at least 30% by mass of the coating solution solvent (dispersion medium) as water, and preferably at least 50% by mass as water. Specific solvent compositions include, for example, the following mixed solutions other than water: water/methanol=85/15; water/methanol=70/30; water/methanol/dimethylformamide (DMF)=80/15/5; water/isopropyl alcohol=60/40 and the like (here, the numerals denote mass ratio).

The primer layer is formed by coating and then drying the above-described coating solution for the primer layer. In the present invention, a bar coater is used as the coating method. Conditions during coating are set so that the wet coating amount is 7.0 ml/m² or more to 30 ml/m² or less, and preferably 8.0 ml/m² or more to 10 ml/m² or less. If the wet coating amount is less than 7.0 ml/m², planar defects quickly occur when agglomerates are formed in the coating solution, although by setting at 7.0 ml/m² or more, the occurrence of planar defects can be prevented even if agglomerates form. If the wet coating amount is more than 30 ml/m², planar defects such as coating unevenness occur, although this can be prevented by setting the wet coating amount to 30 ml/m² or less.

The primer layer may be provided either as a single layer or as two or more layers. However, when providing a plurality of primer layers, each primer layer is successively coated using a bar coater in a wet coating amount during coating of 7.0 ml/m² or more to 30 ml/m² or less, and preferably 8.0 ml/m² or more to 10 ml/m² or less. As a result, the occurrence of planar defects in each primer layer can be prevented. The thickness of each primer layer is about 0.05 to 5 μm per layer, and more preferably about 0.1 to 3 μm per layer.

While the post-coating drying method is not especially limited, the drying may be carried out at a temperature of about 25 to 200° C. for about 0.5 to 20 minutes.

Next, the support will be explained. The film substrate forming the support is preferably polyester. Specific examples include polyethylene terephthalate, polyethylene naphthalate and copolymers or mixtures thereof. The support is preferably transparent. The thickness of the support is preferably 100 to 300 μm.

In order to especially alleviate internal strain remaining in the film during uniaxial drawing to eliminate heat-shrinking strain generated during heat development, a polyester which has undergone heat treatment in a 130 to 185° C. temperature range is preferable as the support, and polyethylene terephthalate (PET) or polyethylene naphthalate (PEN) are especially preferable. For a heat-developable recording material used in medicine, a transparent support may be colored with a blue dye (e.g. dye-1 described in Japanese Patent Application Laid-Open No. 8-240877), or may be colorless.

Next, the photosensitive layer (hereinafter sometimes referred to as “image forming layer”) in the embodiment of the present invention will be explained. The photosensitive layer preferably contains a photosensitive silver halide. The halogen composition of this silver halide is not especially limited, and may be silver chloride, silver chlorobromide, silver bromide, silver iodobromide, and silver iodobromochloride. Among these examples, silver bromide and silver iodobromide are preferred. The distribution of the halogen composition in the grains may be uniform, or the halogen composition may vary in a stepped manner or in a continuous manner. In addition, silver halide grains having a core/shell structure may also be preferably used. An example of a preferable structure is a core/shell structure of 2 to 5 layers, and a more preferable structure is a core/shell structure of 2 to 4 layers. Further, a technique which localizes silver bromide on the surface of silver chloride or silver chlorobromide grains may also be preferably used.

Methods for forming a photosensitive silver halide are well known in the art. For example, the methods described in “Research Disclosure”, No. 17029 (June 1978), and U.S. Pat. No. 3,700,458 can be used. Specifically, a method of adding a silver supply compound and a halogen supply compound to a gelatin or other polymer solution to prepare a photosensitive silver halide, and then mixing it with an organic silver salt is used. Other preferable methods include those described in Japanese Patent Application Laid-Open No. 11-119374 (paragraphs 0217 to 0224), Japanese Patent Application Laid-Open No. 11-98708 and Japanese Patent Application Laid-Open No. 2000-42336.

The grain size of the photosensitive silver halide is preferably small so as to suppress white turbidity after image formation to a low level. Specifically, the grain size no more than 0.20 μm, preferably no less than 0.01 μm to no more than 0.15 μm, and still more preferably no less than 0.02 μm to no more than 0.12 μm. Here, the term “grain size” refers to the diameter as converted to a circular image having the same area as the projected area of the silver halide grain (in the case of a tabular grain, the projected area of the main plane).

Examples of the shape of the silver halide grain include a cubic grain, an octahedral grain, a tabular grain, a spherical grain, a rod-like grain and a potato-like grain. However, in the embodiment of the present invention, cubic grains are especially preferable. A silver halide grain with corners being rounded may also be preferably used. The plane index (Miller index) on the outer surface of the photosensitive silver halide grain is not particularly limited, but a plane having a high spectral sensitization efficiency when a spectral sensitizing dye is adsorbed preferably occupies a larger percentage. This percentage is preferably 50% or more, more preferably, 65% or more and, further preferably, 80% or more. The ratio of the Miller index [100] face can be determined by the method described in J. Imaging Sci., 29, 165 (1985) by T. Tani utilizing the adsorption dependence of [111] face and [100] face in the adsorption of the sensitizing dye.

In the embodiment of the present invention, a silver halide grain where a hexacyano metal complex is present on the outermost surface of the grain is preferred. Examples of the hexacyano metal complex include [Fe(CN)₆]⁴⁻, [Fe(CN)₆]³⁻, [Ru(CN)₆]⁴⁻, [Os(CN)₆]⁴⁻, [Co(CN)₆]³⁻, [Rh(CN)₆]³⁻, [Ir(CN)₆]³⁻, [Cr(CN)₆]³⁻ and [Re(CN)₆]³⁻. In the present invention, a hexacyano Fe complex is preferred.

The hexacyano metal complex is present in the form of ions in an aqueous solution and therefore, the counter cation is not important. However, a cation readily miscible with water and which is suitable for the operation of precipitating the silver halide emulsion is preferably used. Examples thereof include an alkali metal ion, such as a sodium ion, potassium ion, rubidium ion, cesium ion and lithium ion, an ammonium ion and an alkylammonium ion (e.g., tetramethylammonium ion; tetraethylammonium ion, tetrapropylammonium ion, tetra(n-butyl)ammonium ion).

The hexacyano metal complex can be added after mixing it with water, with a mixed solvent of water and an appropriate water-miscible organic solvent (e.g., alcohols, ethers, glycols, ketones, esters, amides) or with gelatin.

The amount of the hexacyano metal complex added is preferably from 1×10⁻⁵ to 1×10⁻² mol, more preferably from 1×10⁻⁴ to 1×10⁻³ mol, per mol of silver.

In order to allow the hexacyano metal complex to be present on the outermost surface of the silver halide grain, a hexacyano metal complex may be directly added in the preparation step from after the completion of addition of an aqueous silver nitrate solution for the grain formation until before the chemical sensitization step of performing chalcogen sensitization such as sulfur sensitization, selenium sensitization and tellurium sensitization or noble metal sensitization such as gold sensitization, during the water washing step, during the dispersion step, or during the chemical sensitization step. To prevent the growth of silver halide fine grains, the hexacyano metal complex is preferably added without delay after the grain formation and preferably before the completion of the preparation step.

The addition of the hexacyano metal complex may be started after 96% by mass of the total amount of silver nitrate for the grain formation has been added, preferably after 98% by mass has been added, and still more preferably after 99% by mass has been added.

When the hexacyano metal complex is added after an aqueous silver nitrate solution has been added immediately before the completion of grain formation, the hexacyano metal complex can adsorb onto the outermost surface of the silver halide grain and mostly form a sparingly soluble salt with the silver ion on the grain surface. The silver salt of hexacyano iron (II) is a more sparingly soluble salt than AgI, and therefore can be prevented from redissolution due to fine grains, thereby allowing a silver halide grain having a small grain size to be produced.

The photosensitive silver halide grain for use in the embodiment of present invention can contain a metal of Groups 8 to 10 of the periodic table (showing from Group 1 to Group 18) or a complex thereof. The metals of Groups 8 to 10 of the periodic table or the center metal of the metal complex is preferably rhodium, ruthenium or iridium. One metal complex may be used or two or more complexes of the same metal or different metals may be used in combination. The content thereof is preferably from 1×10⁻⁹ to 1×10⁻³ mol per mol of silver. The heavy metals, metal complexes and addition method thereof are described in Japanese Patent Application Laid-Open Nos. 7-225449, 11-65021 (paragraphs 0018 to 0024) and 11-119374 (paragraphs 0227 to 0240).

Also, the metal atom (for example, [Fe(CN)₆]⁴⁻) which can be contained in the silver halide grain for use in the embodiment of the present invention, and the desalting method and chemical sensitization method of the silver halide emulsion are described in Japanese Patent Application Laid-Open Nos. 11-84574 (paragraphs 0046 to 0050), 11-65021 (paragraphs 0025 to 0031) and 11-119374 (paragraphs 0242 to 0250).

For gelatins contained in the photosensitive silver halide emulsion used in the embodiment of present invention, various gelatins can be used. Low molecular weight gelatin with a molecular weight of 500 to 60,000 is preferably used in order to favorably maintain the dispersed state of the photosensitive silver halide emulsion in a coating solution containing an organic silver salt. The low molecular weight gelatin may be used upon formation of grains or upon dispersion after the desalting treatment, although it is preferably used during dispersion after the desalting treatment.

As the sensitizing dye which can be used in the embodiment of the present invention, sensitizing dyes that can spectrally sensitize silver halide grains in a desired wavelength region when adsorbed on the silver halide grains and have spectral sensitivity suitable to the spectral characteristic of the exposure light source, can be selected advantageously. The sensitizing dye and the addition method are disclosed in Japanese Patent Application Laid-Open No. 11-65021 (paragraphs 0103 to 0109); as compounds represented by the general formula (II) in Japanese Patent Application Laid-Open No. 10-186572; as dyes represented by the general formula (I) in paragraph 0106 of Japanese Patent Application Laid-Open No. 11-119374; as dyes described in U.S. Pat. Nos. 5,510,236 and 3,871,887 (Example 5); dyes disclosed in Japanese Patent Application Laid-Open Nos. 2-96131 and 59-48753; page 19, line 38 to page 20, line 35 of EP No. 0803764 A1; and Japanese Patent Application Nos. 2000-86865, 2000-102560 and 2000-205399. These sensitizing dyes may be used solely or in combination of two or more thereof. In the embodiment of the present invention, the sensitizing dye is preferably added to the silver halide emulsion in the period between after the desalting step until the coating, and more preferably is added in the period between from the desalting to the completion of chemical ripening. The addition amount of the sensitizing dye in the embodiment of the present invention can be a desirable amount corresponding to the sensitivity and the fogging property; and is preferably in a range from 10⁻⁶ mol to 1 mol and more preferably, from 10⁻⁴ to 10⁻¹ based on one mol of the silver halide in the photosensitive layer.

In the embodiment of the present invention, in order to enhance the spectral sensitization efficiency, a supersensitizer may be used. Examples of the supersensitizer for use in the embodiment of the present invention include the compounds described in EP-A-587338, U.S. Pat. Nos. 3,877,943 and 4,873,184, and Japanese Patent Application Laid-Open Nos. 5-341432, 11-109547 and 10-111543.

The photosensitive silver halide grain for use in the embodiment of the present invention is preferably subjected to chemical sensitization by sulfur sensitization, selenium sensitization or tellurium sensitization. Compounds which may be preferably used in the sulfur sensitization, selenium sensitization and tellurium sensitization include known compounds, such as the compounds described in Japanese Patent Application Laid-Open No. 7-128768. In the embodiment of the present invention, tellurium sensitization is especially preferred, and the compounds described in Japanese Patent Application Laid-Open No. 11-65021 (paragraph 0030) and the compounds represented by general formulae (II), (III) and (IV) of Japanese Patent Application Laid-Open No. 5-313284 are more preferred.

In the embodiment of the present invention, the chemical sensitization may be performed at any step if it is after the grain formation and before the coating. After the desalting, the chemical sensitization may be performed, for example, (1) before spectral sensitization, (2) simultaneously with spectral sensitization, (3) after spectral sensitization or (4) immediately before coating. In the embodiment of the present invention, the amount of sulfur, selenium and tellurium sensitizers used varies depending on the silver halide grain used, chemical ripening conditions and the like, but the amount used is from 10⁻⁸ to 10⁻² mol, preferably on the order of 10⁻⁷ to 10⁻³ mol, per mol of silver halide. In the embodiment of the present invention, the conditions for the chemical sensitization are not particularly limited but the pH is from 5 to 8, the pAg is from 6 to 11 and the temperature is approximately from 40 to 95° C. In the silver halide emulsion used in the embodiment of the present invention, a thiosulfonic acid compound may be added by the method described in EP-A-293917.

In the photosensitive material for use in the embodiment of the present invention, only one photosensitive silver halide emulsion may be used or two or more emulsions (different, for example, in average grain size, halogen composition, crystal habit or chemical sensitization conditions) may be used in combination. By using a plurality of photosensitive silver halide emulsions different in sensitivity, gradation can be controlled. Examples of the technique concerning this point include those described in Japanese Patent Application Laid-Open Nos. 57-119341, 53-106125, 47-3929, 48-55730, 46-5187, 50-73627 and 57-150841. The difference in sensitivity between respective emulsions is preferably 0.2 in terms of log E or more.

The amount of the photosensitive silver halide added is, in terms of the coated silver amount per m² of the photosensitive material, preferably from 0.03 to 0.6 g/m², more preferably from 0.04 to 0.4 g/m², and most preferably from 0.05 to 0.3 g/m². The amount of the photosensitive silver halide added is, per mol of the organic silver salt, preferably from 0.01 to 0.5 mol, and more preferably from 0.02 to 0.3 mol.

The method and conditions for the mixing of separately prepared photosensitive silver halide and organic silver salt are not particularly limited insofar as the effect of the present invention is satisfactorily achieved, but a method of mixing the silver halide grain and organic silver salt, each after the completion of preparation, in a high-speed agitator, a ball mill, a sand mill, a colloid mill, a vibration mill, a homogenizer or the like, or a method of preparing an organic silver salt by mixing a photosensitive silver halide of which preparation is completed, at any timing during the preparation of organic silver salt may be used. For controlling the photographic property, it is preferred to mix two or more aqueous dispersions of organic silver salt with two or more aqueous dispersions of photosensitive silver salt.

In the embodiment of the present invention, the timing of adding the silver halide to a coating solution for the image forming layer is preferably from 180 minutes before coating to immediately before coating, and more preferably from 60 minutes to 10 seconds before coating. However, the mixing method and the mixing conditions are not particularly limited insofar as the effect of the present invention can be satisfactorily achieved. Specific examples of the mixing method include a method of mixing the silver halide with the solution in a tank designed to give a desired average residence time which is calculated from the addition flow rate and the amount of liquid fed to the coater, and a method using a static mixer described, for example, in N. Harnby, M. F. Edwards and A. W. Nienow (translated by Koji Takahashi), Ekitai Kongo Gijutsu (Liquid Mixing Technique), Chap. 8, Nikkan Kogyo Shinbun Ltd. (1989).

The photosensitive layer may also contain silver behenate, or organic silver salt other than silver behenate, as a non-photosensitive organic salt. Such organic silver salt is preferably a silver salt of an organic acid, particularly a silver salt of a long chain aliphatic carboxylic acid (having from 10 to 30 carbon atoms, preferably from 15 to 28 carbon atoms). Preferred examples of the organic silver salt include silver arachidate, silver stearate, silver oleate, silver laurate, silver caproate, silver myristate, silver palmitate and mixtures thereof. Examples of the shape of the silver behenate or organic silver salt other than silver behenate include, but are not limited to, a needle-like shape, rod-like shape, plate-like shape, or scaly shape.

In the embodiment of the present invention, a scaly organic silver salt is preferred. The “scaly organic silver salt” is defined as follows. An organic silver salt is observed by an electron microscope, the shape of the organic silver salt grains is approximated to a cuboid and, assuming the sides of the cuboid as a, b, c (from the shortest side to the largest side, c and b may be identical), x is determined as described below by calculating from the shorter numerical values a, b.

x=b/a

Following the above-described calculation, x is determined for about 200 grains. Assuming the average value thereof as x (average), those satisfying the relation: x (average)≧1.5 are defined as having a scaly shape. Preferably, x satisfies a relation, 30≧x(average)≧1.5, and, more preferably, 20≧x(average)≧2.0. The needle-like shape is defined as: 1≦x(average)≦1.5.

In the scaly grain, a can be regarded as a thickness of a plate-like shaped grain assuming a surface having b and c as sides as a main plane. The average of a is preferably in a range from 0.01 μm to 0.23 μm and, more preferably, from 0.1 μm to 0.201 μm. The average of c/b is, preferably, in a range from 1 to 6, more preferably, from 1.05 to 4, further preferably, from 1.1 to 3 and, particularly preferably, from 1.1 to 2.

The grain size distribution of the organic silver salt gives preferably a mono dispersion. In the mono dispersion, each of percentages of a values obtained by dividing the standard deviation for the length of the minor axis by the minor axis and by dividing the standard deviation for the length of the major axis by the major axis is preferably 100% or less, more preferably, 80% or less and, further preferably, 50% or less. The shape of the organic silver salt can be measured using a transmission type electron microscopic image on the organic silver salt dispersions. Another method of measuring the mono dispersibility is a method of determining the standard deviation of a volume-weighed average diameter of the organic silver salt. The percentage (variation coefficient) of the value obtained by dividing the standard deviation of a volume-weighed average diameter by the volume-weighed average diameter is preferably 100% or less and, more preferably, 80% or less, further preferably, 50% or less. The measuring method can be performed by, for example, irradiating the organic silver salt dispersed in a liquid with a laser beam, and thereby determining the value from the grain size (volume-weighed average diameter) obtained by calculating the auto-correlation function with respect to time variation of the fluctuation of the scattered light.

For the production and the dispersion method of the organic silver salt used in the embodiment of the present invention, known methods can be applied. For example, Japanese Patent Application Laid-Open Nos. 08-234358 and 10-62899, EP Nos. 0803763A1, and 0962812A1, Japanese Patent Application Laid-Open Nos. 11-349591, 2000-7683, 2000-72711, 2000-53682, 2000-75437, 2000-86669, 2000-143578, 2000-178278, 2000-256254, Japanese Patent Application Nos. 11-348228 to 30, 11-203413, 11-115457, 11-180369, 11-297964, 11-157838, 11-202081, 2000-90093, 2000-195621, 2000-191226, 2000-213813, 2000-214155, and 2000-191226 can be referred to.

When a photosensitive silver salt is present during dispersion of the organic silver salt, fogging increases, which dramatically lowers the sensitivity. Hence it is more preferable that the photosensitive silver halide is not substantially contained during dispersion of the organic silver salt. According to the embodiment of the invention, the amount of the photosensitive silver salt contained in an aqueous dispersion to be dispersed is 0.1% by mol or less based on one mol of the organic silver salt in the liquid and it is desirable not to positively add the photosensitive silver salt.

In the embodiment of the present invention, a recording material can be produced by mixing the organic silver salt aqueous dispersion and the photosensitive silver salt aqueous dispersion. The mixing ratio of the organic silver salt to the photosensitive silver salt can be selected according to the purpose; however, the ratio of the photosensitive silver salt to the organic silver salt is preferably from 1 to 30 mol %, more preferably from 3 to 20 mol %, and still more preferably from 5 to 15 mol %. A method of using two or more organic silver salt aqueous dispersions and two or more photosensitive silver salt aqueous dispersions at the mixing is preferably employed for controlling the photographic properties.

While the organic silver salt in the embodiment of the present invention can be used in a desired amount, the amount of silver is preferably in a range from 0.1 to 5.0 g/m², and more preferably, from 1.0 to 3.0 g/m².

In the embodiment of the present invention, the heat-developable photosensitive material preferably contains a reducing agent for the organic silver salt. The reducing agent for the organic silver salt may be any substance (preferably an organic substance) capable of reducing silver ions into metal silver. Examples of the reducing agent include those described in Japanese Patent Application Laid-Open No. 11-65021 (paragraphs 0043 to 0045) and EP-A-0803764 (page 7, line 34 to page 18, line 12). A preferable reducing agent used in the embodiment of the present invention is a hindered phenol type reducing agent or bisphenol type reducing agent. More preferable are compounds represented by general formula (I) of Japanese Patent Application No. 2000-358846.

Specific examples of the reducing agent which can be preferably used in the embodiment of the present invention include those compounds described in Japanese Patent Application No. 2000-358846.

In the embodiment of the present invention, the amount of the reducing agent added is preferably from 0.01 to 5.0 g/m², and more preferably from 0.1 to 3.0 g/m². The reducing agent is preferably contained in an amount of 5 to 50 mol %, more preferably from 10 to 40 mol %, per mol of silver on the side having the photosensitive layer (hereinafter, sometimes referred to as “image forming layer”). The reducing agent is preferably incorporated into the image forming layer.

The reducing agent may be added to the coating solution for incorporating it into the recording material in any form, for example, in the form of a solution, an emulsified dispersion or a solid fine particle dispersion. Well-known examples of the emulsification dispersion method include a method of dissolving the reducing agent using an oil such as dibutyl phthalate, tricresyl phosphate, glyceryl triacetate or diethyl phthalate, and an auxiliary solvent such as ethyl acetate or cyclohexanone, and mechanically forming an emulsified dispersion.

Examples of the solid fine particle dispersion method include a method in which a solid dispersion is prepared by dispersing a reducing agent in an appropriate solvent by a ball mill, colloid mill, vibration ball mill, sand mill, jet mill, roller mill or ultrasonic waves. In this case, a protective colloid (for example, polyvinyl alcohol), surfactant (an anionic surfactant, for example, sodium triisopropylnaphthalene sulfonate (a mixture of compounds each having three isopropyl group on different position)) may also be used. An antiseptic (for example, sodium benzoisothiazolinone) may be incorporated in the aqueous dispersion.

In the embodiment of the present invention, the phenol derivatives represented by formula (A) described in Japanese Patent Application No. 11-73951 can be preferably used as a developer accelerator for the heat-developable recording material to be obtained.

If the reducing agent in the embodiment of the present invention has an aromatic hydroxyl group (—OH), especially in the case of the above-described bisphenol type, it is preferable to use a non-reducing compound having a group capable of forming a hydrogen bond with this group (—OH) therewith. Examples of a group which forms a hydrogen bond with the hydroxyl group or amino group include a phosphoryl group, sulfoxide group, sulfonyl group, carbonyl group, amide group, ester group, urethane group, ureido group, tertiary amino group and nitrogen-containing aromatic group. Among them, preferable compounds include those having a phosphoryl group, sulfoxide group, and amide group (not having a >N—H group and blocked as >N—Ra (Ra is a substituent other than H)), urethane group (not having a >N—H group and blocked as >N—Ra (Ra is a substituent other than H)), and ureido group (not having a >N—H group and blocked as >N—Ra (Ra is a substituent other than H)). In the embodiment of the present invention, especially preferable compounds capable of forming a hydrogen bond include the compounds represented by general formula (II) described in Japanese Patent Application No. 2000-358846.

Specific examples of compounds capable of forming a hydrogen bond which can be preferably used in the embodiment of the present invention include the compounds described in Japanese Patent Application No. 2000-358846.

Specific examples of compounds capable of forming a hydrogen bond further include those described in Japanese Patent Application Nos. 2000-192191 and 2000-194811. The compounds capable of forming a hydrogen-bond represented by general formula (II) described in Japanese Patent Application No. 2000-358846 which can be used in the embodiment of the present invention, like the reducing agent, can be contained in the coating solution in a form of the solution, emulsion dispersion or fine solid grain dispersion to be used in the recording material. Such compound forms a complex having hydrogen bonds with a compound having a phenolic hydroxyl group or amino group in a state of solution. The complex can be isolated in crystalline form by combining with the reducing agent and the compound represented by the general formula (II). Use of the thus-isolated crystalline powder as the fine solid grain dispersion is particularly preferable in order to obtain stable properties. Further, a method of mixing the reducing agent and the compound represented by the general formula (II) in a powder and forming a complex compound during dispersion with a sand grinder mill or the like using an appropriate dispersant can also be used preferably. The compound represented by the general formula (II) is used preferably in a range of 1 to 200% by mol based on the reducing agent, more preferably, in a range of 10 to 150% by mol and, still more preferably, in a range of 30 to 100% by mol.

The binder for the organic silver salt containing layer in the embodiment of the present invention may be any polymer. Preferable binders are transparent or semi-transparent and generally colorless. Examples include natural resin, polymer and copolymer thereof, synthetic resin, polymer and copolymer thereof and other film forming media, for example, gelatins, rubbers, polyvinyl alcohols, hydroxyethyl celluloses, cellulose acetates, cellulose acetate butyrates, polyvinylpyrrolidones, casein, starch, polyacrylic acids, polymethylmethacrylate acids, polyvinyl chlorides, polymethacrylic acids, styrene-maleic acid anhydride copolymers, styrene-acrylonitrile copolymers, styrene-butadiene copolymers, polyvinylacetals (for example, polyvinylformal and polyvinylbutyral), polyesters, polyurethanes, phenoxy resin, polyvinylidene chlorides, polyepoxides, polycarbonates, polyvinyl acetates, polyolefins, cellulose esters and polyamides. The binder may be formed from water or organic solvents or emulsions.

The glass transition temperature of the binder in the layer containing the organic silver salt is preferably from 10° C. or more to 80° C. or less (hereinafter, sometimes referred to as “high Tg binder”). More preferable is from 20° C. or more to 70° C. or less, and still more preferable is from 23° C. or more to 65° C. or less.

Tg is calculated by the following equation:

1/Tg=Σ(Xi/Tgi)

In the equation, it is assumed that n monomer ingredients each corresponding to one of numbers from 1 to n (i=1 to n), are copolymerized in the polymer. Xi represents a weight fraction of the i^{th} monomer (ΣXi=1) and Tgi represents a glass transition temperature (absolute temperature) of a homopolymer of the i^{th} monomer. Σ represents the sum of the value for individual i (i=1 to n). As the value for the glass transition temperature of the homopolymer of each of the monomers (Tgi), the value described in Polymer Handbook (3rd Edition) (written by J. Brandrup, E. H. Immergut (Wiley-Interscience, 1989)) is adopted.

The polymer used for the binder may be, as required, used solely, or in combination of two or more thereof. Further, a polymer having a glass transition temperature of 20° C. or more and a polymer having a glass transition temperature of less than 20° C. may be used in combination. In a case of using a blend of two or more types of polymers having different Tg, it is preferable that the weight average Tg thereof is within the range described above.

For example, in a case in which the organic silver salt containing layer is formed by coating and drying a coating solution comprising water at 30% by mass or more based on the solvent, and further in a case where the binder of the organic silver salt containing layer is soluble or dispersible in water-based solvent (water solvent), and particularly, in a case the binder is comprised of a polymer latex with the equilibrium moisture content at 25° C., 60% RH is 2% by mass or less, properties are improved. A most preferable form is prepared in which the ionic conduction is 2.5 mS/cm or less and the preparation method includes a purification treatment in which a separation membrane is used after synthesis of the polymer.

The water-based solvent in which the polymer is soluble or dispersible described herein is water or water mixed with 70% by mass or less of water miscible organic solvent. The water miscible organic solvent can include, for example, alcohols such as methyl alcohol, ethyl alcohol, and propyl alcohol, cellosolves such as methyl cellosolve, ethyl cellosolve and butyl cellosolve, ethyl acetate and dimethyl formamide.

Even in cases where the polymer does not thermodynamically dissolve, or in other words a system in which the polymer is present in a dispersed state, the term “water-based solvent” is still used in the present application.

Further, “equilibrium moisture content at 25° C., 60% RH” can be represented as below by using the weight W1 of a polymer in a controlled humidity equilibrium in an atmosphere at 25° C., 60% RH and weight W0 of a polymer in an absolutely dried state at 25° C. The definition and the measuring method for the moisture content can be referred, for example, to in Polymer Engineering Course 14, Polymer Material Test Method (edited by the Society of Polymer Science, Chijin Shokan).

The equilibrium moisture content of the binder polymer recited in the invention at 25° C., 60% RH is, preferably, 2% by mass or less, more preferably, from 0.01% by mass or more to 1.5% by mass or less and, still more preferably, from 0.02% by mass or more to 1% by mass or less.

The binder in the embodiment of the present invention is particularly preferably a polymer dispersible in a water-based solvent. Examples of the dispersion state can include a latex in which fine grains of water insoluble hydrophobic polymer are dispersed, or polymer molecules dispersed in a state of a molecule or a micelle. Either of these is preferable. The average grain size of the dispersed grains is, preferably within a range from 1 to 50,000 nm and, more preferably, 5 to 1,000 nm. There is no particular restriction on the grain size distribution of the dispersed grains. The grain size distribution may be either a wide distribution or a mono dispersion.

Preferable embodiments of the polymer dispersible in the water-based solvent in the embodiment of the present invention include hydrophobic polymers such as acrylic polymer, polyesters, rubbers (for example, SBR resin), polyurethanes, polyvinyl chlorides, polyvinyl acetates, polyvinylidene chlorides, and polyolefins. The polymers may be linear, branched or crosslinked polymers. They may be a so-called homopolymer in which single type monomers are polymerized, or copolymer in which two or more types of monomers are polymerized. The copolymer may include random copolymer and block copolymer. The molecular weight of the polymer is from 5,000 to 1,000,000 preferably, 10,000 to 200,000 as a number average molecular weight. Polymers having an excessively small molecular weight are insufficient in kinetic strength of the emulsion layer while those having an excessively large molecular weight have poor film forming property.

Specific examples of the preferable polymer latex can include the following. In the following descriptions, the examples are represented by means of starting monomers, numerical values in brackets represent % by mass and the molecular weight is number average molecular weight. In a case of using a polyfunctional monomer, since the concept of molecular weight can not be applied due to their crosslinked structure, the examples are described as “crosslinking”, with the description for the molecular weight being omitted. Tg represents the glass transition temperature.

P-1; MMA(70)-EA(27)-MAA(3)-Latex (molecular weight 37,000, Tg 61° C.)
P-2; MMA(70)-2EHA(20)-St(5)-AA(5)-Latex (molecular weight 40,000, Tg 59° C.)
P-3; St(50)-Bu(47)-MAA(3)-Latex (crosslinking, Tg −17° C.)
P-4; St(68)-Bu(29)-AA(3)-Latex (crosslinking, Tg 17° C.)
P-5; St(71)-Bu(26)-AA(3)-Latex (crosslinking, Tg 24° C.)
P-6; St(70)-Bu (27)-IA(3)-Latex (crosslinking)
P-7; St(75)-Bu(24)-AA(1)-Latex (crosslinking, Tg 29° C.)
P-8; St(60)-Bu (35)-DVB(3)-MAA(2)-Latex (crosslinking)
P-9; St(70)-Bu (25)-DVB(2)-AA(3)-Latex (crosslinking)
P-10; VC(50)-MMA(20)-EA(20)-AN(5)-AA(5) Latex (molecular weight 80,000)
P-11; VDC(85)-MMA(5)-EA(5)-MAA(5) Latex (molecular weight 67,000)
P-12; Et(90)-MMA(10)-Latex (molecular weight 12,000)
P-13; St(70)-2EHA(27)-AA(3)-Latex (molecular weight 130,000, Tg 43° C.)
P-14; MMA(63)-EA(35)-AA(2)-Latex (molecular weight 33,000, Tg 471° C.)
P-15; St(70.5)-Bu(26.5)-AA(3)-Latex (crosslinking, Tg 23° C.)
P-16; St(69.5)-Bu(27.5)-AA(3)-Latex (crosslinking, Tg 20.5° C.)

Abbreviations for the structure described above represent the following monomers: MMA: methyl methacrylate; EA: ethyl acrylate; MAA: methacrylic acid; 2EHA: 2-ethylhexyl acrylate; St: styrene; Bu: butadiene; AA: acrylic acid; DVB: divinyl benzene; VC: vinyl chloride; AN: acrylonitrile; VDC: vinylidene chloride; Et: ethylene, IA: itaconic acid.

The polymer latexes described above are also marketed and the following polymers can be utilized. Examples of the acrylic polymer include SEVIAN A-4635, 4718, 4601 (all manufactured by Daicel Chemical Industry Co.); and Nipol Lx 811, 814, 821, 820, 857 (all manufactured by Nippon Zeon Co.). Examples of polyesters include FINETEX ES 650, 611, 675, 850 (all manufactured by Dainippon Ink Chemical Co.); and WD-size, WMS (all manufactured by Eastman Chemicals). Examples of polyurethanes include HYDRAN AP 10, 20, 30, 40 (all manufactured by Dainippon Ink Chemical Co.). Examples of rubber include LACSTAR 7310K, 3307B, 4700H, 7132C (all manufactured by Dainippon Ink Chemical Co.); and Nipol LX 416, 410, 438C, 2507 (all manufactured by Nippon Zeon Co.). Examples of polyvinyl chlorides include G351, G576 (all manufactured by Nippon Zeon Co.). Examples of polyvinylidene chlorides include L502, L513 (all manufactured by Asahi Kasei Industry Co.). Examples of polyolefins include, CHEMIPEARL S120, SA100 (both manufactured by Mitsui Petrochemical Co.).

The polymer latex described above may be used alone or, optionally, two or more of them may be blended.

As the polymer latex in the embodiment of the present invention, a latex of styrene-butadiene copolymer is particularly preferable. The weight ratio between the monomer unit of the styrene and the monomer unit of the butadiene in the styrene-butadiene copolymer is preferably 40:60 to 95:5. Further, the proportion of the styrene monomer unit and the butadiene monomer unit in the copolymer is preferably 60 to 99% by mass. A preferable range of the molecular weight is identical with that described above.

The preferable latex of styrene-butadiene copolymer recited in the invention can include the above-described P-3 to P-8, 14, 15, and the commercially available LACSTAR-3307B, 7132C, Nipol LX416 and the like.

In the embodiment of the present invention, a hydrophilic polymer such as gelatin, polyvinyl alcohol, methyl cellulose, hydroxypropyl cellulose and carboxymethyl cellulose may also be added to the organic silver salt containing layer, if necessary. The addition amount of the hydrophilic polymer is preferably 30% by mass or less and, more preferably, 20% by mass or less based on the entire binder in the organic silver salt containing layer.

The organic silver salt containing layer (that is, the image forming layer) in the embodiment of the present invention is preferably formed by using a polymer latex. The binder in the organic silver salt containing layer is preferably contained in an amount in which the weight ratio of entire binder/organic silver salt is in a range from 1/10 to 10/1 and, further preferably, from 1/5 to 4/1.

Further, usually, the organic silver salt containing layer is also a photosensitive layer (emulsion layer) containing the photosensitive silver halide as the photosensitive silver salt in which the weight ratio for the entire binder/silver halide is within a range, preferably, from 400 to 5 and, more preferably, from 200 to 10.

The entire amount of the binder in the image forming layer in the embodiment of the present invention is within a range, preferably, from 0.2 to 30 g/m² and, more preferably, 1 to 15 g/m². In the image forming layer recited in the embodiment of the present invention, a crosslinking agent used for crosslinking and a surfactant for the improvement of the coating properties may also be added.

The solvent for the coating solution for the organic silver salt containing layer of the photosensitive material in the embodiment of the present invention (here, for simplicity, the solvent and the dispersion medium are collectively called “solvent”) is preferably a water-based solvent containing 30% by mass or more of water. As ingredients other than water, any water-miscible organic solvents such as methyl alcohol, ethyl alcohol, isopropyl alcohol, methyl cellosolve, ethyl cellosolve, dimethyl formamide, and ethyl acetate may be used. The water content of the solvent is preferably 50% by mass or more and, further preferably, 70% by mass or more. Preferable specific examples of the solvent composition can include water, water/methyl alcohol=90/10, water/methyl alcohol=70/30, water/methyl alcohol/dimethylformamide=80/15/5, water/methyl alcohol/ethyl cellosolve=85/10/5 and water/methyl alcohol/isopropyl alcohol=85/10/5 (numerical values represent % by mass).

Examples of the antifoggant, stabilizer and stabilizer precursor which can be used in the embodiment of the present invention include those described in Japanese Patent Application Laid-Open No. 10-62899 (paragraph 0070) and EP-A-0803764 (page 20, line 57 to page 21, line 7), and compounds described in Japanese Patent Application Laid-Open Nos. 9-281637 and 9-329864. The antifoggant preferably used in the embodiment of the present invention is an organic halide. Examples thereof include those disclosed in Japanese Patent Application Laid-Open No. 11-65021 (paragraphs 0111 to 0112). In particular, the organic halogen compounds represented by formula (P) of Japanese Patent Application No. 11-87297, the organic polyhalogen compounds represented by general formula (II) of Japanese Patent Application Laid-Open No. 10-339934, and the organic polyhalogen compounds described in Japanese Patent Application No. 11-205330 are preferred. Organic polyhalogen compounds which can be preferably used in the embodiment of the present invention include the compounds represented by formula (III) of Japanese Patent Application No. 2000-358846. Specific examples thereof include the compounds described in the specification of that patent application.

The compound represented by formula (III) of Japanese Patent Application No. 2000-358846 is preferably used in the range from 10⁻⁴ to 1 mol, more preferably from 10⁻³ to 0.8 mol, still more preferably from 5×10⁻³ to 0.5 mol, per mol of the non-photosensitive silver salt in the image forming layer. In the embodiment of the present invention, for incorporating the antifoggant into the recording material, the methods described above for the incorporation of reducing agent may be used. The organic polyhalogen compound is also preferably added in the form of a solid fine particle dispersion.

Other examples of the antifoggant include the mercury (II) salts described in Japanese Patent Application Laid-Open No. 11-65021 (paragraph 0113), the benzoic acids described in the same patent publication (paragraph 0114), the salicylic acid derivatives described in Japanese Patent Application Laid-Open No. 2000-206642, the formalin scavenger compounds represented by formula (S) of Japanese Patent Application Laid-Open No. 2000-221634, the triazine compounds according to claim 9 of Japanese Patent Application Laid-Open No. 11-352624, the compounds represented by formula (III) of Japanese Patent Application Laid-Open No. 6-11791, and 4-hydroxy-6-methyl-1,3,3a,7-tetrazaindene.

In the embodiment of the present invention, an azolium salt may be incorporated to act as an antifoggant. Examples of the azolium salt include compounds represented by general formula (XI) of Japanese Patent Application Laid-Open No. 59-193447, the compounds described in Japanese Patent Publication 55-12581, and the compounds represented by formula (II) of Japanese Patent Application Laid-Open No. 60-153039. Concerning the addition timing of the azolium salt, it may be added at any step from the preparation of the organic silver salt to preparation of the coating solution, and it is preferably added at a time from the preparation of organic silver salt to just before coating. The azolium salt may be added by any method such as in the form of powder, solution and fine grain dispersion. Further, it may be added as a solution mixed with other additives such as a sensitizing dye, reducing agent, toning agent or the like. In the embodiment of the present invention, the addition amount of the azolium salt may be any amount and it is, preferably, in a range from 1×10⁻⁶ mol to 2 mol and, further preferably, from 1×10⁻³ mol to 0.5 mol based on one mol of silver.

According to the embodiment of the present invention, for controlling development by suppressing or promoting development, for improving the spectral sensitizing efficiency and improving the storage properties before and after development, mercapto compounds, disulfide compounds and thion compounds can be incorporated. Examples thereof include those described in Japanese Patent Application Laid-Open No. 10-62899 (paragraphs 0067 to 0069), the compounds represented by the general formula (I) of Japanese Patent Application Laid-Open No. 10-186572 (specific examples are disclosed in paragraphs 0033 to 0052), EP-A-0803764A1, page 20, lines 36 to 56 and Japanese Patent Application No. 11-273670. Among them, mercapto substituted heterocyclic aromatic compounds are preferable.

In the embodiment of the present invention, a toning agent is preferably added. Examples of the toning agent include those described in Japanese Patent Application Laid-Open No. 10-62899 (paragraphs 0054 to 0055), EP-A-0803764A1, page 21, lines 23-48, Japanese Patent Application Laid-Open No. 2000-356317 and Japanese Patent Application No. 2000-187298. Preferred examples include phthalazinones (phthalazinone, phthalazinone derivatives or metal salts; for example, 4-(1-naphthyl) phthalazinone, 6-chlorophthalazinone, 5,7-dimethoxyphthalazinone and 2,3-dihydro-1,4-phthalazinedione); combinations of phthalazinones and phthalic acids (for example, phthalic acid, 4-methyl phthalic acid, 4-nitro phthalic acid, diammonium phthalate, sodium phthalate, potassium phthalate, and tetrachloro phthalic acid anhydride); phthalazines (phthalazine, phthalazine derivatives or metal salts; for example, 4-(1-naphthyl)phthalazine, 6-isopropyl phthalazine, 6-t-butyl phthalazine, 6-chlorophthalazine, 5,7-dimethoxyphthalazine and 2,3-dihydrophthalazine). The combination of a phthalazine and a phthalic acid is particularly preferable.

A plasticizer and lubricant which can be used in the photosensitive layer of the embodiment according to the present invention are described in Japanese Patent Application Laid-Open No. 11-65021 (paragraph 0117). The ultrahigh contrast-providing agent for the formation of an ultrahigh contrast image and the addition method and amount added thereof are described in Japanese Patent Application Laid-Open Nos. 11-65021 (paragraph 0118), 11-223898 (paragraphs 0136 to 0193), and 11-87297 (compounds represented by formula (H), formulae (1) to (3) and formulae (A) and (B)), Japanese Patent Application No. 11-91652 (compounds represented by formulae (III) to (V), specifically, the compounds of chemical formulae 21 to 24). The ultrahigh contrast-promoting agent is described in Japanese Patent Application Laid-Open Nos. 11-65021 (paragraph 0102) and 11-223898 (paragraphs 0194 and 0195).

To use formic acid or formate as a strong fogging agent, it is preferable to contain 5 millimoles or less of formic acid or formate, and more preferably 1 millimole or less per one mol of silver, on the side having the image forming layer containing the photosensitive silver halide.

In the embodiment of the present invention, if using an ultrahigh contrast-providing agent, it is preferable to use an acid resulting from hydration of diphosphorus pentoxide or a salt thereof. Examples of the acid resulting from hydration of diphosphorus pentoxide, and the salt thereof, include metaphosphoric acid (and salts thereof), pyrophosphoric acid (and salts thereof), orthophosphoric acid (and salts thereof), triphosphoric acid (and salts thereof), tetraphosphoric acid (and salts thereof) and hexametaphosphoric acid (and salts thereof). Particularly preferred are orthophosphoric acid (and salts thereof) and hexametaphosphoric acid (and salts thereof). Specific examples of the salt include sodium orthophosphate, sodium dihydrogenorthophosphate, sodium hexametaphosphate and ammonium hexametaphosphate. The amount used (coated amount per m² of the recording material) of the acid resulting from hydration of diphosphorus pentoxide or a salt thereof may be appropriately selected to match the performance such as sensitivity and fog, but is preferably from 0.1 to 500 mg/m², and more preferably from 0.5 to 100 mg/m².

In the embodiment of the present invention, a surface protective layer may be provided so as to prevent adhesion of the image forming layer. The surface protective layer may be a single layer or may be composed of a plurality of layers. The surface protective layer is described in Japanese Patent Application Laid-Open Nos. 11-65021 (paragraphs 0119 and 0120) and 2000-171936. In the embodiment of the present invention, the binder for the surface protective layer is preferably gelatin but polyvinyl alcohol (PVA) is also preferably used or used in combination with gelatin. Examples of the gelatin which can be used include inert gelatin (e.g., Nitta Gelatin 750) and phthalated gelatin (e.g., Nitta Gelatin 801). Examples of PVA include those described in Japanese Patent Application Laid-Open No. 2000-171936 (paragraphs 0009 to 0020) and preferred examples thereof include completely saponified product PVA-105, partially saponified products PVA-205 and PVA-335, and modified polyvinyl alcohol MP-203 (trade names, produced by Kuraray Co., Ltd.). The coated amount (per m² of the support) of polyvinyl alcohol of the protective layer (per one layer) is preferably from 0.3 to 4.0 g/m², more preferably from 0.3 to 2.0 g/m².

In the embodiment of the present invention, particularly in the case of using the heat-developable recording material of the present invention for printing where the dimensional change becomes a problem, a polymer latex is preferably used for the surface protective layer or the back layer. The polymer latex for such a purpose is described in Taira Okuda and Hiroshi Inagaki (editors), Gosei Jushi Emulsion (Synthetic Resin Emulsion), Kobunshi Kankokai (1978), Takaaki Sugimura, Yasuo Kataoka, Soichi Suzuki and Keishi Kasahara (editors), Gosei Latex no Oyo (Application of Synthetic Latex), Kobunshi Kankokai (1993), and Soichi Muroi, Gosei Latex no Kagaku (Chemistry of Synthetic Latex), Kobunshi Kankokai (1970). Specific examples of the polymer latex include a latex of methyl methacrylate (33.5% by mass)/ethyl acrylate (50% by mass)/methacrylic acid (16.5% by mass) copolymer, a latex of methyl methacrylate (47.5% by mass)/butadiene (47.5% by mass)/itaconic acid (5% by mass) copolymer, a latex of ethyl acrylate/methacrylic acid copolymer, a latex of methyl methacrylate (58.9% by mass)/2-ethylhexyl acrylate (25.4% by mass)/styrene (8.6% by mass)/2-hydroxyethyl methacrylate (5.1% by mass)/acrylic acid (2.0% by mass) copolymer and a latex of methyl methacrylate (64.0% by mass)/styrene (9.0% by mass)/butyl acrylate (20.0% by mass)/2-hydroxyethyl methacrylate (5.0% by mass)/acrylic acid (2.0% by mass) copolymer. For the binder of the surface protective layer, the combination of polymer latexes described in Japanese Patent Application No. 11-6872, and the techniques described in Japanese Patent Application Nos. 11-143058 (paragraphs 0021 to 0025), 11-6872 (paragraphs 0027 and 0028), and 10-199626 (paragraphs 0023 to 0041) can be applied. The percentage of the polymer latex in the surface protective layer is preferably from 10 to 90% by mass, more preferably from 20 to 80% by mass, based on the entire binder. The coated amount (per m² of the support) of the entire binder (including water-soluble polymer and latex polymer) for the surface protective layer (per one layer) is preferably from 0.3 to 5.0 g/m², more preferably from 0.3 to 2.0 g/m².

In the embodiment of the present invention, the preparation temperature of the coating solution for the image forming layer is preferably from 30° C. or more to 65° C. or less, more preferably from 35° C. or more to less than 60° C., and still more preferably from 35° C. or more to 55° C. or less. Furthermore, the coating solution for the image forming layer immediately after the addition of the polymer latex is preferably kept at a temperature of 30° C. or more to 65° C. or less.

In the embodiment of the present invention, the image forming layer is composed of one or more layers on the support. In the case where the image forming layer is composed of a single layer, the layer comprises an organic silver salt, a photosensitive silver halide, a reducing agent and a binder, and if desired, additionally contains additional materials such as a toning agent, coating aid and other adjuvants. In the case where the image forming layer is composed of two or more layers, a first image forming layer (usually a layer adjacent to the support) contains an organic silver salt and a photosensitive silver halide, and a second image forming layer or these two layers contain some other components. In the structure of a multicolor photosensitive heat-developable photographic material, a combination of these two layers may be provided for each color or as described in U.S. Pat. No. 4,708,928, all the components may be contained in a single layer. In the case of a multi-dye multicolor photosensitive heat-developable photographic material, the emulsion layers are held separately from each other by interposing a functional or nonfunctional barrier layer between respective photosensitive layers, as described in U.S. Pat. No. 4,460,681.

In the present invention, the photosensitive layer may contain various dyes or pigments (for example, C.I. Pigment Blue 60, C.I. Pigment Blue 64, C.I. Pigment Blue 15:6) from the standpoint of improving the color tone, inhibiting the generation of interference fringes on laser exposure or preventing the irradiation. These are described in detail in WO98/36322, and Japanese Patent Application Laid-Open Nos. 10-268465 and 11-338098.

In the embodiment of the present invention, an antihalation layer may be provided on the side farther from a light source with respect to the photosensitive layer.

In the embodiment of the present invention, a non-photosensitive layer is ordinarily added in addition to the photosensitive layer. The non-photosensitive layer can be classified by its position into (1) a protective layer provided on a photosensitive layer (on the side farther from the support), (2) an interlayer provided between a plurality of photosensitive layers or between a photosensitive layer and a protective layer, (3) a primer layer provided between a photosensitive layer and a support, and (4) a back layer provided on the side opposite to the photosensitive layer. A filter layer is provided in the recording material as the layer (1) or (2). An antihalation layer is provided in the recording material as the layer (3) or (4).

The antihalation layer is described in Japanese Patent Application Laid-Open Nos. 11-65021 (paragraphs 0123 and 0124), 11-223898, 9-230531, 10-36695, 10-104779, 11-231457, 11-352625 and 11-352626. The antihalation layer contains an antihalation dye having absorption at the exposure wavelength. In the case where the exposure wavelength is present in the infrared region, an infrared ray-absorbing dye is used and in such a case, the dye preferably has no absorption in the visible region. In the case of preventing halation using a dye having absorption in the visible region, preferably substantially no color of the dye remains after the formation of an image. For this purpose, means capable of decolorizing under the action of heat at the heat development is preferably used. In particular, the non-photosensitive layer is preferably rendered to function as an antihalation layer by adding thereto a thermally decolorizable dye and a base precursor. Japanese Patent Application Laid-Open No. 11-231457 describes these techniques.

The amount of the decolorizable dye added is determined according to the use of the dye. In general, the decolorizable dye is used in an amount of giving an optical density (absorbance) in excess of 0.1 when measured at the intended wavelength. The optical density is preferably from 0.2 to 2. For attaining such an optical density, the amount of the dye used is ordinarily on the order of 0.001 to 1 g/m².

By such decolorization of the dye, the optical density after heat development can be reduced to 0.1 or less. Two or more decolorizable dyes may be used in combination in the thermally decolorizable recording material or heat-developable photosensitive material. Also, two or more base precursors may be used in combination. In the thermal decolorization using the decolorizable dye and base precursor, for example, a substance (e.g., diphenylsulfone, 4-chlorophenyl(phenyl)sulfone) capable of lowering the melting point by 3° C. or more when mixed with the base precursor, described in Japanese Patent Application Laid-Open No. 11-352626 is preferably used in combination in terms of thermal decolorizability and the like.

In the embodiment of the present invention, a coloring agent having an absorption maximum at 300 to 450 nm may be added for the purpose of improving silver color tone or preventing change over time. Examples of such a coloring agent include those described in Japanese Patent Application Laid-Open Nos. 62-210458, 63-104046, 63-103235, 63-208846, 63-306436, 63-314535, and 01-61745, Japanese Patent Application No. 11-276751. The coloring agent is usually added in the range from 0.1 mg/m² to 1 g/m². The layer to which the coloring agent is added is preferably a back layer provided on the side opposite to the photosensitive layer.

In the embodiment of the present invention, the obtainable heat-developable photosensitive material is preferably a so-called single-sided recording material having at least one photosensitive layer containing a silver halide emulsion on one side of the support and having a back layer on the other side.

In the embodiment of the present invention, a matting agent is preferably added for improving the conveyance property. Examples of the matting agent include those described in Japanese Patent Application Laid-Open No. 11-65021 (paragraphs 0126 and 0127). The amount of the matting agent added is, in terms of the coated amount per m² of the photosensitive material, preferably from 1 to 400 mg/m², and more preferably from 5 to 300 mg/m². The matting degree on the emulsion surface may be any value insofar as a stardust failure does not occur, but is preferably, in terms of Bekk smoothness, from 30 to 2,000 seconds, and more preferably from 40 to 1,500 seconds. The Bekk smoothness can be easily determined according to Japanese Industrial Standard (JIS) P8119, “Paper and Paperboard Smoothness Testing Method by Bekk Smoothness Tester”, and TAPPI Standard Method T479.

In the embodiment of the of the present invention, the matting degree of the back layer is such that the Bekk smoothness is preferably from 10 seconds or more to 1,200 seconds or less, more preferably from 20 seconds or more to 800 seconds or less, and still more preferably from 40 seconds or more to 500 seconds or less.

In the embodiment of the present invention, the matting agent is preferably incorporated into the outermost surface layer, a layer acting as the outermost surface layer, or a layer close to the outer surface, of the recording material, or is preferably incorporated into a layer acting as a protective layer.

The back layer which can be applied to the present invention is described in Japanese Patent Application Laid-Open No. 11-65021 (paragraphs 0128 to 0130).

In the embodiment of the present invention, the obtainable heat-developable recording material preferably has a pH on the film surface before heat development of 7.0 or less, and more preferably 6.6 or less. The lower limit thereof is not particularly limited, but is about 3. The most preferred pH range is from 4 to 6.2. For adjusting the pH on the film surface, a nonvolatile acid such as an organic acid (e.g., phthalic acid derivative) or sulfuric acid, or a volatile base such as ammonia is preferably used from the standpoint of reducing the pH on the film surface. In particular, ammonia is preferred for achieving a low film surface pH, because ammonia is readily volatilized and can be removed in the coating step or before the heat development. Furthermore, the combination of ammonia with a nonvolatile base such as sodium hydroxide, potassium hydroxide or lithium hydroxide is also preferred. The method of measuring the pH on the film surface is described in Japanese Patent Application No. 11-87297 (paragraph 0123).

In the embodiment of the present invention, a hardening agent may be used in each layer such as photosensitive layer, protective layer and back layer. Preferred examples of the hardening agent include those described in T. H. James, The Theory of the Photographic Process, Fourth Edition, pp. 77-87, Macmillan Publishing Co., Inc. (1977), chrome alum, 2,4-dichloro-6-hydroxy-s-triazine sodium salt, N,N-ethylenebis(vinylsulfonacetamide), N,N-propylenebis(vinylsulfonacetamide), the polyvalent metal ion described in ibid., page 78, the polyisocyanates described in U.S. Pat. No. 4,281,060 and Japanese Patent Application Laid-Open No. 6-208193, the epoxy compounds described in U.S. Pat. No. 4,791,042, and the vinyl sulfone-base compounds described in Japanese Patent Application Laid-Open No. 62-89048.

The hardening agent is added as a solution. The timing of adding the solution to the coating solution for protective layer is from 180 minutes before coating to immediately before coating, and preferably from 60 minutes to 10 seconds before coating. The mixing method and conditions for the mixing are not particularly limited insofar as the effect of the present invention is satisfactorily achieved. Specific examples of the mixing method include a method of mixing the solutions in a tank designed to give a desired average residence time which is calculated from the addition flow rate and the amount of solutions fed to the coater, and a method of using a static mixer described, for example, in N. Harnby, M. F. Edwards and A. W. Nienow (translated by Koji Takahashi), Ekitai Kongo Gijutsu (Liquid Mixing Technique), Chap. 8, Nikka Kogyo Shinbun Ltd. (1989).

The surfactant which can be applied to the present invention is described in Japanese Patent Application Laid-Open No. 11-65021 (paragraph 0132). The solvent is described in paragraph No. 0133 of the same patent publication, the support is described in paragraph No. 0134 of the same patent publication, the antistatic or electrically conducting layer is described in paragraph No. 0135 of the same patent publication, the method for obtaining a color image is described in paragraph No. 0136 of the same patent publication, and the slipping agent is described in Japanese Patent Application Laid-Open No. 11-84573 (paragraphs 0061 to 0064) and Japanese Patent Application No. 11-106881 (paragraphs 0049 to 0062).

In the embodiment of the present invention, the obtainable heat-developable recording material is preferably a mono-sheet type (a type where an image can be formed on the heat-developable recording material without using another sheet such as image-receiving material).

In the embodiment of the present invention, either of the photosensitive layer or the non-photosensitive layer may further contain an antioxidant, a stabilizer, a plasticizer, an ultraviolet absorbent and a coating aid. These additives are described in WO98/36322, EP-A-803764, and Japanese Patent Application Laid-Open Nos. 10-186567 and 10-18568.

In the embodiment of the present invention, each of the above-described layers may be coated by any method. Specifically, various coating operations including extrusion coating, slide coating, curtain coating, dip coating, knife coating, flow coating, and extrusion coating using a hopper of the type described in U.S. Pat. No. 2,681,294 may be used. The extrusion coating or slide coating described in Stephen F. Kistler and Petert M. Schweizer, LIQUID FILM COATING, pp. 399-536, CHAPMAN & HALL (1977) is preferred and the slide coating is more preferred. An example of the shape of the slide coater used in the slide coating is shown in FIG. 11b.1 of ibid., page 427. If desired, two or more layers may be simultaneously coated using a method described in ibid., pp. 399-536, U.S. Pat. No. 2,761,791 and British Patent No. 837,095.

The coating solution for the organic silver salt-containing layer used in the embodiment of the present invention is preferably a so-called thixotropic fluid. The technique is described in Japanese Patent Application Laid-Open No. 11-52509. The coating solution for the organic silver salt-containing layer used in the embodiment of the present invention preferably has a viscosity of 400 mPa·s or more to 100,000 mPa·s or less, and more preferably from 500 mPa·s or more to 20,000 mPa·s or less, at a shear rate of 0.1 s⁻¹. At a shear rate of 1,000 s⁻¹, the viscosity is preferably from 1 mPa·s or more to 200 mPa·s or less, and more preferably from 5 mPa·s or more to 80 mPa·s or less.

Examples of the techniques which can be used in the embodiment of the present invention include those described in EP-A-803764, EP-A-883022, WO98/36322, Japanese Patent Application Laid-Open Nos. 56-62648, 58-62644, 9-43766, 9-281637, 9-297367, 9-304869, 9-311405, 9-329865, 10-10669, 10-62899, 10-69023, 10-186568, 10-90823, 10-171063, 10-186565, 10-186567, 10-186569 to 10-186572, 10-197974, 10-197982, 10-197983, 10-197985 to 10-197987, 10-207001, 10-207004, 10-221807, 10-282601, 10-288823, 10-288824, 10-307365, 10-312038, 10-339934, 11-7100, 11-15105, 11-24200, 11-24201, 11-30832, 11-84574, 11-65021, 11-109547, 11-125880, 11-129629, 11-133536 to 11-133539, 11-133542, 11-133543, 11-223898, 11-352627, 11-305377, 11-305378, 11-305384, 11-305380, 11-316435, 11-327076, 11-338096, 11-338098, 11-338099, 11-343420, 2000-187298, 2000-10229, 2000-47345, 2000-206642, 2000-98530, 2000-98531, 2000-112059, 2000-112060, 2000-112104, 2000-112064 and 2000-171936.

In the embodiment of the present invention, the obtainable heat-developable recording material may be developed by any method. Usually, a heat-developable recording material exposed imagewise is developed by temperature elevation. A preferable developing temperature is in a range from 80 to 250° C., and more preferably from 100 to 140° C. The developing time is, preferably, in a range from 1 to 60 sec, more preferably, from 5 to 30 sec and, particularly preferably, from 10 to 20 sec.

A plate heater method is preferable for the heat developing method. For a thermal development system by the plate heater method, a method described in Japanese Patent Application Laid-Open No. 11-133572 is preferable. This method discloses a heat-developable apparatus, in which a heat-developable recording material on which a latent image is formed is brought into contact with heating device at a heat development station, whereby a visible image is obtained on the heat-developable recording material. The heating device comprises a plate heater. A plurality of opposed retainer rollers are disposed along one surface of the plate heater. The heat-developable recording material is passed between the retainer rollers and the plate heater to conduct heat development. It is preferable that the plate heater is divided into 2 to 6 stages and the temperature is lowered by about 1 to 10° C. for the top end. Such a method is described also in Japanese Patent Application Laid-Open No. 54-30032 and moisture or an organic solvent contained in the heat-developable recording material can be eliminated out of the system. Further, deformation of the support of the heat-developable recording material caused by rapid heating of the heat-developable recording material can be suppressed.

In the embodiment of the present invention, the obtainable heat-developable recording material may be exposed by any method, although a laser beam is preferable as the exposure light source. Examples of the laser used in the present invention include a gas laser (Ar⁺, He—Ne), a YAG laser, a dye laser and a semiconductor laser. Further, a semiconductor laser and a second harmonic generator can also be used. Preferable examples include a gas laser or a semiconductor laser emitting red-infrared light.

Examples of a laser imager for medical use having an exposure station and a heat developing station include the Fuji Medical Dry Einager FM-DPL. This system is described in Fuji Medical Review No. 8, pp. 39-55. The techniques of this apparatus can obviously be utilized as a laser imager for a heat-developable recording material. Further, the heat-developable recording material used for the laser imager proposed in “AD network” by Fuji Medical Co. can be applied as a network system compatible with DICOM Standard.

In the embodiment of the present invention, the obtainable heat-developable recording material forms a black-and-white image by a silver image and is used preferably for the heat-developable recording material for medical diagnosis, for industrial photography, for printing and for COM.

While an example applicable to the undercoating of a silver halide photosensitive material has been explained above, the present invention can also preferably be applied to the undercoating of other photosensitive materials or optical film materials. The same advantages can also be achieved when used as an undercoating material for a water-based latex, gelatin, PVA and the like, a polyester resin binder, a polyurethane resin binder, UV curable resin, material for a graft polymer and the like.

1. A base treatment method of a polyester film, comprising the step of
subjecting a surface of a polyester film having a surface roughness Ra of no less than 0.5 nm and no more than 1.0 nm to a remote plasma treatment, to introduce a functional group thereon.

2. The base treatment method of a polyester film according to claim 1, wherein
the polyester film is a polyethylene terephthalate film.

3. The base treatment method of a polyester film according to claim 1, wherein
the remote plasma treatment is carried out with an O₂ or CO₂ plasma, and the functional group is set in a range which satisfies 0.45<O/C<0.55.

4. The base treatment method of a polyester film according to claim 1, wherein
the remote plasma treatment is carried out with an N₂ or NH₃ plasma, and the functional group is set in a range which satisfies 0.05<N/C<0.3.

5. The base treatment method of a polyester film according to claim 1, wherein
a water-based base primer layer is coated onto a surface of the polyester film which has been subjected to the remote plasma treatment.

6. A polyester film article, wherein
the polyester film article is produced by subjecting a surface of a polyester film having a surface roughness Ra of no less than 0.5 nm and no more than 1.0 nm to a remote plasma treatment, to introduce a functional group thereon.

7. The base treatment method of a polyester film according to claim 2, wherein
the remote plasma treatment is carried out with an O₂ or CO₂ plasma, and the functional group is set in a range which satisfies 0.45<O/C<0.55.

8. The base treatment method of a polyester film according to claim 2, wherein
the remote plasma treatment is carried out with an N₂ or NH₃ plasma, and the functional group is set in a range which satisfies 0.05<N/C<0.3.

9. The base treatment method of a polyester film according to claim 2, wherein
a water-based base primer layer is coated onto a surface of the polyester film which has been subjected to the remote plasma treatment.

10. The base treatment method of a polyester film according to claim 3, wherein
a water-based base primer layer is coated onto a surface of the polyester film which has been subjected to the remote plasma treatment.

11. The base treatment method of a polyester film according to claim 4, wherein
a water-based base primer layer is coated onto a surface of the polyester film which has been subjected to the remote plasma treatment.

12. The base treatment method of a polyester film according to claim 7, wherein
a water-based base primer layer is coated onto a surface of the polyester film which has been subjected to the remote plasma treatment.

13. The base treatment method of a polyester film according to claim 8, wherein
a water-based base primer layer is coated onto a surface of the polyester film which has been subjected to the remote plasma treatment.
